(19) United States
(12) Patent Application Publication
(10) Pub. No.: US 2023/0242248 A1
(43) Pub. Date: Aug. 3, 2023

(54) ROTOR BLADE NOZZLE GENERATING AIR PRESSURE SYSTEM

(71) Applicant: Donald Lee Adle, Clearwater, FL (US)

(72) Inventor: Donald Lee Adle, Clearwater, FL (US)

(21) Appl. No.: 17/588,281

(22) Filed: Jan. 29, 2022

(51) Int. Cl. B64C 27/467; B64C 11/18

(52) U.S. Cl. CPC B64C 27/467; B64C 11/18

(57) ABSTRACT

A method for using a rotorcraft main blades or airframe propeller whereby by using a convergent-divergent nozzle with a choked nozzle. The said main nozzle being a component of the said main blades having a rotation system. The said nozzle airflow transmits power giving movement by the said blades through the said propeller rotational movement with maximum thrust and efficiency. The said convergent-divergent nozzle achieves maximum thrust efficiency increasing kinetic energy output.

### REFERENCE TO MICROFICHE APPENDIX

Not applicable.

### STATEMENT REGARDING FEDERALLY SPONSORED RESEARCH OR DEVELOPMENT

Not applicable.

### CROSS REFERENCE TO RELATED APPLICATIONS

Not applicable.

### INDUSTRIAL APPLICABLITY

Rotor Blades Nozzle Generating Air Pressure System is method for a Airframe which generates air lift and/or an air forward drive system. The said system that relate to air “also known as gases, fluid” mixture mainly of oxygen and nitrogen. The invention, is energy-efficient, meeting all requirements by any regulatory body and in accordance with any regulations that impacting the polluting of the air industry.

### BACKGROUND

Airframe is a type of rotorcraft or airplane that uses a powered of the main blades to develop lift and the propeller to develop forward movement. The main blades disc and the propeller disc, is to permit incoming ambient downstream air to communication to the main blades and the propeller. The propeller is shaped much like a wing of an aircraft, using the rotation power of an engine rotates the propeller produce lift (this lift is referred to as thrust) which moves the aircraft forward. Permit incoming ambient downstream air to increase kinetic energy to provide more efficient flying.

### TECHNICAL FIELD

The object of the present invention is to provide a method for by a combination of the main mast 2 is coupled to the main hub 4, the said main hub 4 is coupled to the main blades 6. The main nozzle 8 with each one having an air inlet and an air outlet. The said main nozzle 8 is the component of the said main blades 6. The said main hub 4 provided by a combination of an ample supply of the said main blades 6. The said main blades 6 with an of ample supply of the said main nozzle 8. These said main nozzle 8 to be used on the airframe tail rotor system too.

The said main nozzle 8 with having one is a tube that is pinched in the middle, making an a carefully balanced, asymmetric shape. The said main blades 6 system are the rotating part of an airframe which generates lift and forward movement. The airframe providing a combination of the said main blades 6 with the goal to increase kinetic energy to provide more efficient flying.

And the object of the present invention is to provide a method for by a combination of the propeller mast 10 is coupled to the propeller hub 12, the said propeller hub 12 is coupled to the propeller 14. The said propeller nozzle 16 with each one having an air inlet and an air outlet. The said propeller nozzle 16 is the component of the said propeller 14. The said propeller hub 12 provided by a combination of an ample supply of the said propeller 14. The said propeller 14 with an of ample supply of the said propeller nozzle 16. These said propeller nozzle 16 to be used on the airframe the said propeller 14 system.

The said propeller nozzle 16 with having one is a tube that is pinched in the middle, making an a carefully balanced, asymmetric shape. The said propeller 14 system are the rotating part of an airframe which generates lift and forward movement. The airframe providing a combination of the said propeller 14 and using the said propeller nozzle 16 with the goal to increase kinetic energy to provide more efficient flying.

### SUMMARY

The present invention relates to a method for the main blades 6 with an ample supply of the main nozzle 8 to be used to convert pressure energy to kinetic energy to produce thrust. The said main nozzle 8 a component of the said main blades 6. The said main blades 6 in by using the said main nozzle 8 to be used to convert pressure energy to kinetic energy to produce thrust.

At the said main blades 6 side of the main hub 4 is the attachment point for the said main blades 6. The said main nozzle 8 with having one is a tube that is pinched in the middle, making an a carefully balanced, asymmetric shape.

The focuses are on using the said main nozzle 8 to attain supersonic flow and optimizing it to achieve maximum thrust without flow separation due to Shock waves. For maximum thrust and efficiency, the direction of the flow must be parallel to the axis of the said main nozzle 8. The said main nozzle 8 inlet opening to be parallel of the top side the said main blades 6 and the said main nozzle 8 outlet opening parallel of the bottom side the said main blades 6.

The airframe rotor is powered by the engine, through the transmission, to the rotating of the main mast 2. The said main mast 2 shaft that extends from the transmission. At the top of the said main mast 2 is the attachment point for the said main hub 4. At the said main blades 6 side of the said main hub 4 is the attachment point for the said main blades 6. The goal of the said main nozzle 8 is to increase kinetic energy to provide more efficient flying.

Frequently, the goal of the said main blades 6 and the said main nozzle 8 is to increase the kinetic energy of the flowing medium at the expense of its pressure and internal energy. These the said main nozzle 8 can be described as convergent (narrowing down from a wide diameter to a smaller diameter in the direction of the flow) or divergent (expanding from a smaller diameter to a larger one). The said main nozzle 8 with having one is a tube that is pinched in the middle, making an a carefully balanced, asymmetric shape.

The said main blades 6 of an airframe are long, narrow airfoils with a high aspect ratio, a shape that minimizes drag from tip vortices. They generally contain a degree of washout that reduces the lift generated at the tips, where the airflow is fastest and vortex generation would be a significant problem. The said main blades 6 and the said main blades 6 are made of various materials, including aluminum, composite structure, and steel or titanium, with abrasion shields along the leading edge. The said main blades 6 and the said main blades 6 are traditionally passive; however, some airframes include active components on their blades. The said main blades 6 are traditionally passive; however, some airframes include active components on their blades.

Convergent nozzle accelerate subsonic fluids. If the said main nozzle 8 pressure ratio is high enough, then the flow will reach sonic velocity at the narrowest point. In this situation, the said main nozzle 8 is said to be choked that has a choked in the convergent section and the shape of the divergent section also ensures that the direction of the escaping air also known gases is directly backwards, as any sideways component would not contribute to thrust. Increasing the said main nozzle 8 pressure ratio further will not increase the throat Mach number above one.

And the present invention the propeller 14 of an airframe, a shape that minimizes drag from tip vortices. And relates to a method for the said propeller 14 with an ample supply of the propeller nozzle 16 to be used to convert pressure energy to kinetic energy to produce thrust. The said propeller nozzle 16 a component of the said propeller 14. The said propeller 14 in by using the said propeller nozzle 16 to be used to convert pressure energy to kinetic energy to produce thrust.

At the said propeller 14 side of the propeller hub 10 is the attachment point for the said propeller 14. The said propeller nozzle 16 with having one is a tube that is pinched in the middle, making an a carefully balanced, asymmetric shape.

The focuses are on using the said propeller nozzle 16 to attain supersonic flow and optimizing it to achieve maximum thrust without flow separation due to Shock waves. For maximum thrust and efficiency, the direction of the flow must be parallel to the axis of the said propeller nozzle 16. The said propeller nozzle 16 inlet opening to be parallel of the top side the said propeller 14 and the said propeller nozzle 16 outlet opening parallel of the bottom side the said propeller 14.

And the airframe rotor is powered by the engine, through the transmission, to the rotating of the said propeller mast 10. The said propeller mast 10 shaft that extends from the transmission. At the top of the said propeller mast 10 is the attachment point for the propeller hub 12. At the said propeller 14 side of the said propeller hub 12 is the attachment point for the said propeller 14. The goal of the said propeller nozzle 16 is to increase kinetic energy to provide more efficient flying.

And Frequently, the goal of the said propeller 14 and with the said propeller nozzle 16 is to increase the kinetic energy of the flowing medium at the expense of its pressure and internal energy. The said propeller nozzle 16 can be described as convergent narrowing down from a wide diameter to a smaller diameter in the direction of the flow or divergent expanding from a smaller diameter to a larger one. The said propeller nozzle 16 with having one is a tube that is pinched in the middle, making an a carefully balanced, asymmetric shape.

The said propeller 14 of an airframe are with a shape that minimizes drag from tip vortices. They generally contain a degree of washout that reduces the lift generated at the tips, where the airflow is fastest and vortex generation would be a significant problem. The said propeller 14 and the said propeller 14 are made of various materials, including aluminum, composite structure, and steel or titanium, with abrasion shields along the leading edge. The said propeller 14 are traditionally passive; however, some airframes include active components on their blades.

Convergent nozzle accelerate subsonic fluids. If the said propeller nozzle 16 pressure ratio is high enough, then the flow will reach sonic velocity at the narrowest point. In this situation, the said propeller nozzle 16 is said to be choked that has a choked in the convergent section and the shape of the divergent section also ensures that the direction of the escaping air also known gases is directly backwards, as any sideways component would not contribute to thrust. Increasing the said propeller nozzle 16 pressure ratio further will not increase the throat Mach number above one.

### REFERENCE NUMBERS IN THE DRAWING AND WRITINGS

main mast 2, main hub 4, main blades 6, main nozzle 8, propeller mast 10, propeller hub 12, propeller 14, propeller nozzle 16.

### INCREASING GAS VELOCITY

The main nozzle 8 with having one is a tube that is pinched in the middle, making an a carefully balanced, asymmetric shape The said main nozzle 8 with having one with an inlet and each one with an outlet. The said main nozzle 8 is the component of the main blades 6.

The said main nozzle 8 is shaped tube through which air flow. At the throat, where the cross-sectional area is at its minimum, the gas velocity locally becomes sonic, a condition called choked flow that has a choked in the convergent section and the shape of the divergent section also ensures that the direction of the escaping air also known gases is directly backwards, as any sideways component would not contribute to thrust. As the said main nozzle 8 and the said main nozzle 8 cross-sectional area increases, the gas begins to expand, and the gas flow increases to supersonic velocities where a sound wave will not propagate backwards through the nozzle.

And the propeller nozzle 16 with having one is a tube that is pinched in the middle, making an a carefully balanced, asymmetric shape increasing gas velocity. The said propeller nozzle 16 is the component of the propeller 14.

The said propeller nozzle 16 is shaped tube through which air flow. At the “throat”, where the cross-sectional area is at its minimum, the gas velocity locally becomes sonic, a condition called choked flow that has a choked in the convergent section and the shape of the divergent section also ensures that the direction of the escaping air also known gases is directly backwards, as any sideways component would not contribute to thrust. As the said propeller nozzle 16 cross-sectional area increases, the gas begins to expand, and the gas flow increases to supersonic velocities where a sound wave will not propagate backwards through the nozzle.

### INFORFORMATION

Atmospheric gases: The common name given to the atmospheric gases used in breathing and photosynthesis is fluid. In a fluid, the molecules have enough energetic so that the effect of intermolecular forces is small, and the typical distance between neighboring molecules is much greater than the molecular size.

Atmospheric pressure: Is the force per unit area exerted on a surface by the weight of fluid above that surface, the higher the atmospheric pressure, the higher the ambient fluid pressure buildup. The incoming ambient fluid pressure causes a vacuum in the high-pressure regions. The vacuum in the front of the molecules causes the molecules to accelerate toward the low-pressure regions.

Atmospheric pressure: Drawing of its gases from the high-pressured regions causes a vacuum in front of the high-pressured regions. This causes a vacuum “low pressure” in the atmospheric high-pressure regions, this vacuum in front of the high pressure causes the molecules to accelerate toward the low-pressure regions.

Bernoulli equation: States that, here points 1 and 2 lie on a streamline, the fluid has constant density, the flow is steady, and there is no friction. Pressure/velocity variation: Consider the steady, flow of a constant density fluid in a converging duct, without losses due to friction. The flow therefore satisfies all the restrictions governing the use of Bernoulli’s equation. Upstream and downstream of the contraction we make the one-dimensional assumption that the velocity is constant over the inlet and outlet areas and parallel. When streamlines are parallel, the pressure is constant across them, except for hydrostatic head differences (if the pressure was higher in the middle of the duct, for example, we would expect the streamlines to diverge, and vice versa). If we ignore gravity, then the pressures over the inlet and outlet areas are constant. Along a streamline on the centerline, the Bernoulli equation and the one-dimensional continuity equation give, respectively.

Bernoulli principle: The correlation between fluid speed and pressure, as speed increases pressure decreases, as the fluid is curving. The continuous change of position of a body of fluid stream curving so that every partied of the body follows a straight-line path.

Conservation laws, in physics: A corresponding volume must move a greater distance in their narrowing of the passageways and thus have a greater speed. At the same time, the work done by corresponding volumes in the narrowing of the passageways will be expressed by the product of the pressure and the volume. Since the speed is greater in the narrowing of the passageways, the energetic of that volume is greater. Then, by the law of conservation of energy, this increase in kinetic energy must be balanced by a decrease in the pressure-volume product, or, since the volumes are equal, by a decrease in pressure.

Convergent-divergent type of nozzle: Nozzle are used to modify the flow of a fluid (i.e., by increasing kinetic energy of the flow in expense of its pressure). Convergent-divergent type of nozzle; mostly used for supersonic flows because it is impossible to create supersonic flows in convergent type of nozzle and therefore it restricts us to a limited amount of mass flow through a particular nozzle. In convergent-divergent type of nozzle we can increase the flow velocity much higher than sonic velocity that is why these types of nozzles have a wide application such as propelling nozzle in jet engines or in fluid intake for engines working at high rpms.

Converging and diverging portions: The converging portion has a greater diameter than the diverging portion. The converging portion has a high capacity and a low velocity. The diverging portion will have a low capacity and a high velocity with a back pressure. The ambient pressure, referred to as lower atmospheric pressure, “back pressure” causes the fluid stream to accelerate. By reducing the pressure of the gases at the exit of the expansion portion, in effect, the molecules leave the outlets at their thermal speed without colliding with other molecules. This is because the molecules are all moving in the same relative direction and at the same speed.

A de Lava with nozzle (or convergent-divergent nozzle, CD nozzle or con-di nozzle) is a tube that is pinched in the middle, making a carefully balanced, asymmetric hourglass shape. In a subsonic flow sound will propagate through the gas. At the “throat”, where the cross-sectional area is at its minimum, the gas velocity locally becomes sonic (Mach number = 1.0), a condition called choked flow. In a supersonic de Lava with nozzle: It is used to accelerate a hot, pressurized gas passing through it to a higher supersonic speed in the axial (thrust) direction, by converting the heat energy of the flow into kinetic energy.

And for subsonic flows, convergent nozzle is used and for supersonic flows a convergent-divergent (CD) nozzle is employed also known as a de Lava with nozzle (or convergent-divergent nozzle, CD nozzle or con-di nozzle). In a CD nozzle flow is accelerated from low subsonic to sonic velocity at the throat and further expanded to supersonic velocities at the exit.

A de Laval type nozzle: A nozzle is a shaped tube through which not fluid flow. At the “throat”, where the cross-sectional area is at its minimum, the gas velocity locally becomes sonic (Mach number = 1.0), a condition called choked flow. As the nozzle cross-sectional area increases, the gas begins to expand and the gas flow increases to supersonic velocities where a sound wave will not propagate backwards through the gas as viewed in the frame of reference of the nozzle (Mach number > 1.0). This nozzle configuration is called a convergent-divergent, or CD, nozzle.

Kinetic Molecular Theory of Matter: Is a concept that basically states that atoms and molecules possess energy of motion “kinetic energy” that we perceive as temperature. In other words, atoms and molecules are constantly in motion, and we measure the energy of these movements as the temperature of that substance. This means if there is an increase in temperature, the atoms and molecules will gain more energy “kinetic energy” and move even faster.

Kinetic momentum: The momentum which a particle possesses because of its motion, equal to the particle’s mass times it velocity. The rotational energetic depends on rotation about an axis, and for a body of constant moment of inertia is equal to the product of half the moment of inertia times the square of the angular velocity. In relativistic physics kinetic energy is equal to the product of the increase of mass caused by motion times the square of the speed of light.

Pressure: Is a defined as the force per unit area exerted against a surface by the weight of the fluid above that surface. In terms of molecules, if the number of molecules above a surface increase, there are more molecules to exert a force on that surface and consequently, the pressure increases.

### BRIEF DESCRIPTION OF THE DRAWINGS

The above and other objects, features and other advantages of the present invention will be more clearly understood from the following propeller description taken in conjunction with the accompanying drawings, in which:

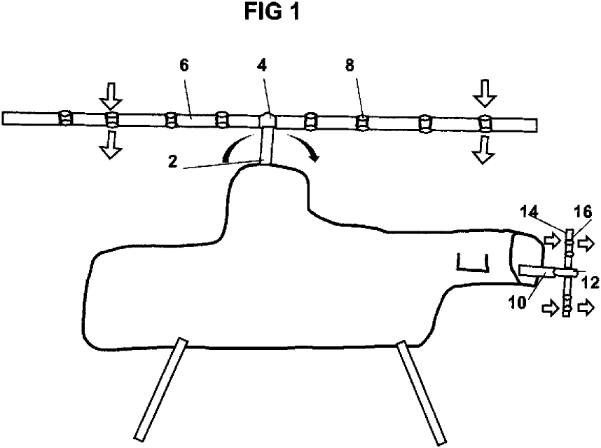

FIG. 1 is a perspective view illustrating an airframe; main mast 2, main hub 4, main blades 6, main nozzle 8, and propeller mast 10, propeller hub 12, propeller 14, propeller nozzle 16, according to the present invention.

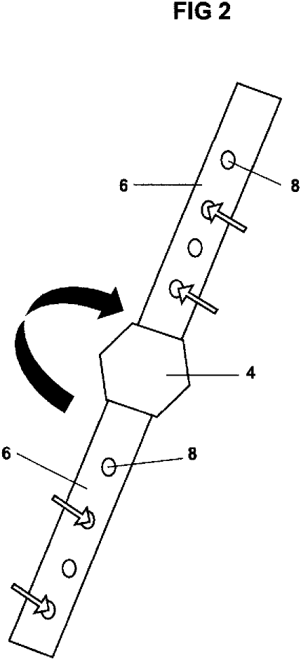

FIG. 2 is a cross-sectional view illustrating; main hub 4, main blades 6, main nozzle 8, according to the present invention.

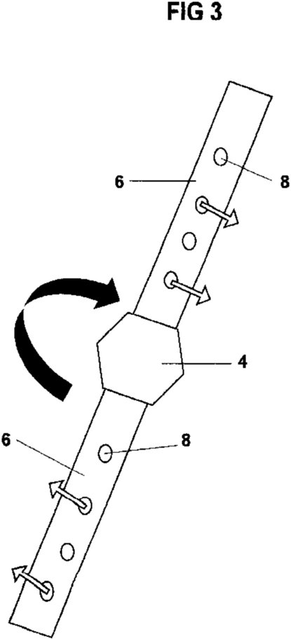

FIG. 3 is a cross-sectional view illustrating; propeller hub 12, propeller 14, propeller nozzle 16, according to the present invention.

### DESCRIPTION OF THE PREFERRED EMBODIMENT

The airframe rotor is powered by the engine, through the transmission, to the rotating of the main mast 2. The said main mast 2 shaft that extends from the transmission. At the top of the said main mast 2 is the attachment point for the main hub 4. At the main blades 6 side of the said main hub 4 is the attachment point for the said main blades 6.

The said main blades 6 with a rotating the said main hub 4 and radiating the said main blades 6 that are set at a pitch to form a helical spiral, that, when rotated, exerts linear thrust of air flow, and exerts some of the linear thrust of air to the main nozzle 8 The said main nozzle 8 a component of the said main blades 6. The said main nozzle 8 inlet opening to be parallel of the top side the said main blades 6 and the outlet opening parallel of the bottom side the said main nozzle 8.

The said main nozzle 8 being a convergent-divergent that has a choked in the convergent section and the shape of the divergent section also ensures that the direction of the escaping air also known gases is directly backwards as any sideways component would not contribute to thrust, and the said main blades 6 having an air inlet opening and an air outlet opening.

And the airframe rotor is powered by the engine, through the transmission, to the rotating of the propeller mast 10. The said propeller mast 10 shaft that extends from the transmission. At the top of the said propeller mast 10 is the attachment point for the propeller hub 12. At the propeller 14 side of the said propeller hub 12 is the attachment point for the said propeller 14.

The said propeller 14 with a rotating the said propeller hub 12 and radiating the said propeller 14 that are set at a pitch to form a helical spiral, that, when rotated, exerts linear thrust of air flow, and exerts some of the linear thrust of air to the propeller nozzle 16. The said propeller nozzle 16 a component of the said propeller 14. The said propeller nozzle 16 inlet opening to be parallel of the top side the said propeller 14 and the said propeller nozzle 16 outlet opening parallel of the bottom side the said propeller 14.

The said propeller nozzle 16 being a convergent-divergent that has a choked in the convergent section and the shape of the divergent section also ensures that the direction of the escaping air also known gases is directly backwards as any sideways component would not contribute to thrust, and the said propeller 16 having an air inlet opening and an air outlet opening.

### Embodiment: In Different Forms

While the invention is susceptible to embodiment in many different forms, it will be understood that various modifications may be made to the embodiment disclosed herein. For example, dimensions may vary and are only approximations of a preferred embodiment, and any suitable fasteners may be utilized to operatively connect the various elements described herein. In addition, the nozzle, and its construction may be varied, as would be known in the art.

Likewise, the number and structure of the nozzle, etc. Also, the orientation of the nozzle, for example, they could be at a different angle than illustrated, or be in line with each other, as would be known to those of skill in the art. Therefore, the above description should not be construed as limiting, but merely as exemplifications of a preferred embodiment.

Those skilled in the art will envision other modifications within the scope, spirit, and intent of the invention as shown in the drawings and will be described to herein in detail, specific embodiments thereof with the understanding that the present disclosure is to be considered as an exemplification of the principles of the invention and is not to be limited to the specific embodiments described.

Each one of the examples is provided by way of explanation of the invention, not limitation of the invention. In fact, it will be apparent to those skilled in the art that various modifications and variations can be made in the present invention without departing from the scope or spirit of the invention.

For instance, features illustrated or described as component of one embodiment can be used same component with another other component to yield a still further embodiment.

Thus, it is intended that the present invention covers such modification and variations as come within the scope of the appended claims and their equivalents. Embodiments described with reference to accompanying figures, wherein like reference numbers designate corresponding or identical elements throughout the figures. It should be appreciated that the present invention is not limited to any type or style depicted in figures, for illustrative purposes only. It should be appreciated that the present invention is not limited to any type or style depicted in Figure’s and is for illustrative purposes only.

### Ramifications of Detailed Description

Although preferred embodiments have been depicted and described in detail therein, it will be apparent to those skilled in the relevant art that various modifications, additions, substitutions, and the like can be made without departing from the spirit of the invention and these are therefore considered to be within the scope of the invention as defined in the following claims. All air, fluid temperatures, pressurized gases, gases velocity or gases pressures used are an estimate, based on information attained.

Changes could be made without departing from essence present invention, by having other kinds of moving devices, such as using other kinds of motors or multi-speed turbo motors to drive the air “fluid” stream. Having the motor placed in other locations. Having the apparatus to use other kinds of air “gases” blower holes or volutes. Other kinds of power sources, like using solar energy. Use isolation material and formulation to reduce vibrations and dissipate shock energy for the blade, nozzle, and gases mover.

Changes could be made without departing from essence present invention, by having other kinds of nozzle with the subsonic de Lava nozzle: Like in determining the shape of the blade with nozzle in the Mach number. Like deflection in the blade and or the nozzle with prescribed geometry that includes inlet and exit nozzle angles, blade line and thickness distribution.

Other change could be having nozzle intake or outlet, placed higher or lower, smaller, or larger, more or less of them on the kinds of blades or nozzle. There are other kinds of convergent-divergent nozzle, or de Laval type nozzle or other kinds of nozzle with having one is a tube that is pinched in the middle, making an a carefully balanced, asymmetric shape.

I claim is:

1. The main blades of claim 1: A blade convergent-divergent geometry nozzle outlet affix on main blade, main blade means on blade convergent-divergent geometry nozzle the air drawn into the intake and centrifugally flung outwardly of the blade convergent-divergent geometry nozzle outlet, convergent-divergent geometry nozzle affix on propeller; means on propeller convergent-divergent geometry nozzle the air drawn into the intake and centrifugally flung outwardly of the blade convergent-divergent geometry nozzle outlet.

2. The main blades and propeller system of claim 1, wherein a blade convergent-divergent geometry nozzle outlet affix on main blade, main blade means on blade convergent-divergent geometry nozzle the air drawn into the intake and centrifugally flung outwardly of the blade convergent-divergent geometry nozzle outlet.

3. The main blades and propeller system of claim 1, wherein convergent-divergent geometry nozzle affix on propeller; means on propeller convergent-divergent geometry nozzle the air drawn into the intake and centrifugally flung outwardly of the blade convergent-divergent geometry nozzle outlet.
